(19) United States
(12) Patent Application Publication
(10) Pub. No.: US 2016/0173784 A1
(43) Pub. Date: Jun. 16, 2016

(54) APPARATUS AND METHOD FOR PROVIDING OF ROTATION IMAGE

(71) Applicant: Hyangjin LEE, Johns Creek, GA (US)

(72) Inventor: Hyangjin LEE, Johns Creek, GA (US)

(21) Appl. No.: 14/572,439

(22) Filed: Dec. 16, 2014

(51) Int. Cl. H04N 5/232; G06F 17/30; H04N 5/44; H04N 5/262

(52) U.S. Cl. CPC H04N 5/23296; H04N 5/2628; G06F 17/3028; H04N 5/44; H04N 5/23238

(57) ABSTRACT

Provided is an apparatus and a method for providing a rotation image that can output a plurality of still images taken by a camera into rotation images through a simple user interface, on its portable multimedia device or the display unit of specific terminal. According to the present invention, a still image-creating app of a still image unit or a rotation image-creating app of a rotation image app is transmitted to a client terminal and/or user terminal through a data transceiver. The present invention can provide a rotation image using the apps.

### BACKGROUND

The present invention relates to an apparatus and a method for providing an image which displays a taken image into another type of image on a terminal, and more particularly, to an apparatus and a method for providing a rotation image which display a plurality of still images in a type that a user wants, if necessary.

Recently, portable multimedia devices having various functions have been developed, with the development of multimedia devices. Portable multimedia devices having the function of a camera that takes still images or moving images, in those devices, has been increasingly popularized, various functions have been added.

Accordingly, various ways of displaying taken images have been introduced and those functions have been used in various fields.

In addition to taking and displaying still images or moving images in the related art, various photographing techniques using special equipment have also been proposed.

A typical one of the photographing techniques, which has been popularized, is to take still images of an object in the type of a panorama or simultaneously at several angles with a plurality of cameras disposed at the several angles around the object and then to output the still images continuously or like a 3D image using various output ways.

However, such a technique of providing images is limited in space, because it can be achieved only under the environment with a plurality of cameras and a system for rotating the cameras or a videos system for outputting a 3D image.

Accordingly, even if portable multimedia devices that are widely used now are equipped with a camera of a displayer, only several preset methods are used within limits to take a plurality of various images using the camera on the portable multimedia devices and display the images in desired ways on the displayer.

### SUMMARY OF THE INVENTION

An aspect of the present invention provides an apparatus and a method for providing rotation images which can output a plurality of still images taken by a camera in a pivot type on a portable multimedia device or a display unit of a specific terminal, using a simple user interface.

According to an aspect of the present invention, there is provided an apparatus for providing a rotation image that is connected with a plurality of client terminals and/or user terminals and provides a rotation image. The apparatus includes: a member information storage storing member information on the terminals; a data transceiver connected with the terminals to transmit/receive data; a still image unit providing a still image-creating app to the terminals and keeping and processing received still images; a rotation image unit providing a rotation image-creating app to the terminals and receiving and keeping rotation images; and a server controller controlling the components so that any one of the apps is selectively transmitted by request from a terminal and a rotation image is provided to a terminal requesting the rotation image.

the rotation image unit includes: a rotation image-creating app storage keeping the rotation image-creating app and a rotation image storage keeping rotation images transmitted from the terminals.

the still image unit includes: a still image-creating app storage keeping the sill image-creating app, a still image storage keeping still images transmitted from the terminals, and a still image processor creating rotation images by processing still images in the still image storage.

The terminals each may include: a rotation image-creating app storage keeping a requested and receive rotation image-creating app; a data transceiver transmitting/receiving data; a still image camera operated by the rotation image-creating app and taking still images; a still image processor processing still images taken by the still image camera to output them into rotation images; a rotation image storage keeping the rotation images processed by the still image processor; a rotation image display unit reading out and displaying the rotation images in the rotation image storage; and a controller controlling the components so that a plurality of still images are taken by received the rotation image-creating app and displayed in rotation images.

The terminals each may include: a still image-creating app storage keeping a requested and received still image-creating app; a data transceiver transmitting still images to the still image unit and receiving rotation images; a still image camera operated by the still image-creating app to take a still image; a rotation image storage keeping a rotation image transmitted from the data transceiver; a rotation image display unit reading out and displays the rotation image in the rotation image storage; and a controller controlling the components so that a plurality of still image is taken by the received still image-creating app and the received rotation images are displayed.

Another aspect of the present invention, there is provided an apparatus for providing a rotation image that is connected with a plurality of client terminals and/or user terminals and provides rotation images. The apparatus may include: a member information storage storing member information on the terminals; a data transceiver connecting with the terminals to transmit/receive data; a rotation image unit providing a rotation image-creating app to the terminals and receiving and keeping rotation images; and a server controller controlling the components so that the rotation image-creating app is transmitted by request from a terminal, and a rotation image is transmitted from the terminal and then provided to the terminal, in which the terminals each may include: a rotation image-creating app storage keeping a requested and receive rotation image-creating app; a data transceiver transmitting/receiving data to/from the data transceiver; a still image camera operated by the rotation image-creating app and taking still images; a still image processor processing still images taken by the still image camera to output them into rotation images; a rotation image storage keeping the rotation images processed by the still image processor; a rotation image display unit reading out and displaying the rotation images in the rotation image storage; and a controller controlling the components so that a plurality of still images are taken by received the rotation image-creating app and displayed in rotation images.

According to another aspect of the present invention, there is provided an apparatus for providing a rotation image that is connected with a plurality of client terminals and/or user terminals and provides rotation images. The apparatus may include: a member information storage storing member information on the terminals; a data transceiver connecting with the terminals to transmit/receive data; a still image unit providing a still image-creating app to the terminals and keeping and processing received still images; and a server controller controlling the components so that the still image-creating app is transmitted by request from a terminal, and a still image transmitted from the terminal is processed and then provided as a rotation image to the terminal requesting the terminal, in which the terminals each may include: a still image-creating app storage keeping a requested and received still image-creating app; a data transceiver transmitting still images and receiving rotation image; a still image camera operated by the still image-creating app to take a still image; a rotation image storage keeping a rotation image transmitted from the data transceiver; a rotation image display unit reading out and displays the rotation image in the rotation image storage; and a controller controlling the components so that a plurality of still image is taken by the received still image-creating app and the received rotation images are displayed.

the rotation image display unit is a touch screen and the controller controls an output rotation image to be rotated when the touch screen is touched.

the apps have camera driving control data keeping the photographing time, the photographing angle, and the number of times of photographing of the still image camera so that the still image camera takes a plurality of still images of an object throughout 360 degrees, and when the still image camera is connected to a rotation system, the apps further have photographing environment data for controlling a driving motor of the rotation system on the basis of the parameters set in the camera driving control data.

the rotation system rotates the still image camera about an object position, the rotation system includes: a swivel member to which the still image camera is detachably mounted and which is rotatable about the object position; a driving motor rotating the swivel member; and a motor controller controlling the driving motor by controlling power for the driving motor, and the motor controller automatically stops the driving motor, when a signal for controlling the driving motor is not received for a predetermined time.

the controller controls rotation images transmitted from the terminal to another terminal or rotation images transmitted from another terminal to be sequentially arranged and displayed in the order of reception on the rotation image display unit, controls any one of the rotation image transmitted from the terminal or the rotation image transmitted from another terminal to be displayed as a picture icon at a side or the other side of the rotation image display unit, and controls the picture icons to be activated in a rotation image having a predetermined size and displayed on the rotation image display unit, when the picture icon is selected for rotation of the image.

the apparatus (the terminal) further comprising, an upload setting unit setting rotation images in the rotation image storage to be transmitted and uploaded to a specific website.

the apparatus (the terminal) further comprising, a production information provider keeping product information so that product information of an article shown in the rotation image is set to be uploaded by the upload setting unit and uploaded with the rotation image to the specific website, and providing the stored product information to the upload setting unit.

The still image camera may be rotated by a rotation system, and a motor controller of the rotation system may automatically stop the driving motor, when a signal for controlling the driving motor is not received for a predetermined time.

A controller of the terminal controls at least two rotation images in the rotation image storage to be divided and outputted on the rotation image display unit.

A controller of the terminal may control characters showing the transmission time of a transmitted rotation image and the sender of a received rotation image or the reception time of a received rotation image to be displayed on the rotation image display unit.

The controller of the terminal may control the rotation image display unit so that characters inputted to the terminal or received from another terminal are displayed in the type of a word bubble at a side of the picture icon.

According to another aspect of the present invention, there is provided a method of providing a rotation image that provides rotation images in connection with a plurality of client terminals and/or user terminals that request an app. The method may include: a first step of transmitting any one of a still image-creating app or a rotation image-creating app to a terminal requesting the app in response to a requested signal; and a second step of processing or keeping an input still image to be outputted at a rotation image or keeping an input rotation image, when any one of a still image and a rotation image is inputted, after the still image-creating app or the rotation image-creating app is transmitted.

the first step include: a step 1-1 that determines whether the requested signal is a signal for requesting a still image-creating app; a step 1-2 that determines whether the requested signal is a signal for requesting a rotation image-creating app, when the requested signal is not a signal for requested a still image-creating app, as the result of determination; a step 1-3 that transmits a rotation image-creating app to a terminal requesting the rotation image-creating app, when the requested signal is a signal for requesting a rotation image-creating app, as the result of determination in the step 1-2; and a step 1-4 that transmits a still image-creating app to a terminal requesting the still image-creating app, when a signal for requesting a still image-creating app is inputted in the step 1-1.

the second step includes: determining whether the input image is a still image; processing an input still image to be outputted as a rotation image, when the input image is determined as a still image; and keeping the processed rotation image.

the second step includes: determining whether the input image is a rotation image; and keeping an input rotation image when the input image is determined as a rotation image.

According to another aspect of the present invention, there is provided a method of providing a rotation image that provides rotation images in connection with a plurality of client terminals and/or user terminals that request an app. The method may include: a first step of determining whether a requested signal is a signal for requesting a still image-creating app; a second step of determining whether the requested signal is a signal for requesting a rotation image-creating app, when the requested signal is not a signal for requesting a still image-creating app; a third step of transmitting a rotation image-creating app to a terminal requesting the rotation image-creating app, when the requested signal is a signal for requesting a rotation image-creating app, as the result of determination in the second step; a fourth step of keeping an input rotation image, when the rotation image is inputted, after the rotation image-creating app is transmitted; a fifth step of transmitting a still image-creating app to a terminal requesting the still image-creating app, when a signal for requesting a still image-creating app is inputted in the first step; a sixth step of determining whether a still image is inputted, after the still image-creating app is transmitted; a seventh step of processing an input still image to be outputted as a rotation image, when the still image is inputted, as the result of determination in the sixth step; and an eighth step of keeping the processed rotation image.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic diagram illustrating an apparatus for providing rotation images;

FIG. 2 is a block diagram illustrating in detail the central server illustrated in FIG. 1;

FIG. 3 is a block diagram illustrating in detail a terminal according to an embodiment of the present invention;

FIG. 4 is a block diagram illustrating in detail a terminal according to another embodiment of the present invention;

FIG. 5 is a control flowchart illustrating a method of providing rotation images according to an embodiment of the present invention;

FIG. 6 is a side view illustrating the configuration of a rotation system according to an embodiment of the present invention;

FIG. 7 is a view illustrating a swivel member of the rotation system according to an embodiment of the present invention; and

FIG. 8 is a diagram illustrating the screen of a terminal according to an embodiment of the present invention.

### DETAILED DESCRIPTION OF THE PREFERRED EMBODIMENT

Exemplary embodiments of the present invention will now be described in detail with reference to the accompanying drawings.

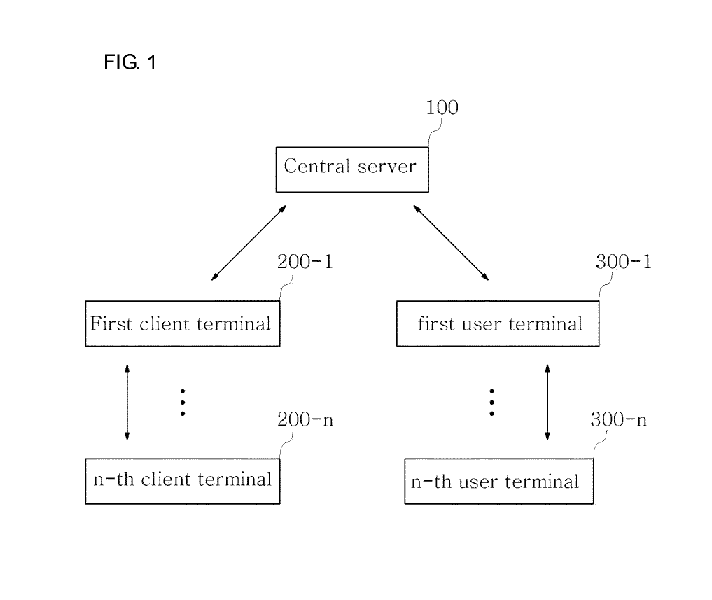

Hereinafter, preferred embodiments of the present invention will be described in detail with reference to FIGS. 1 to 8.

FIG. 1 is a schematic diagram illustrating an apparatus for providing rotation images.

Referring to FIG. 1, the apparatus illustrated in FIG. 1 includes: a central server 100 that provides rotation images including applications (hereafter, referred to as ‘app’) by request; first to n-th client terminals 200-1 to 200-n that are connected and capable of transmitting/receiving data to request the central server 100 to display rotation images; and first to n-th user terminals 300-1 to 300-n that are connected to transmit/receive data, which is transmitted to the client terminals 200-1 to 200-n and the central server 100, to/from each other.

The central server 100 can provide an app capable of outputting a rotation image by request from the first client terminal 200-1, for example, at a pet shop.

The first to n-th client terminals 200-1 to 200-n may be cameras, displays, or terminal having a communication function (for example, a smartphone or a tablet PC) of the owners of pet shops, or may be specific terminals having a display function (for example, for a show window) and connected with a digital camera.

The first to n-th user terminals 300-1 to 300-n may be terminals having the same function as the first client terminal 200-1 and belonging to customers using pet shops.

For example, a customer with the first user terminal 300-1 whose dog receives beauty treatment in a pet shop with the first client terminal 200-1 can see the appearance of the dog after the beauty treatment from a rotation image on his/her terminal and share it with other user terminals. Similarly, the first to n-th user terminals 300-1 to 300-n can share the appearances of dogs provided after beauty treatment at different pet shops.

For example, when users of the first to n-th user terminals 300-1 to 300-n are in a social network group of people having the same kind of dogs, they can communicate with each other by sharing the rotation images of the dogs after beauty treatment provided from the first to n-th client terminals 200-1 to 200-n of the owners of pet shops, so they can select pet shops providing better beauty treatment. Further, the users of the first to n-th user terminals 300-1 to 300-n may communicate with each other by receiving an app capable of outputting a rotation image from the central server 100, takes still images of the appearances of their dog in person after beauty treatment, and then displaying and sharing rotation images.

Accordingly, the owners of pet shops with the first to n-th client terminals 200-1 and 200-n can provide rotation images of various appearances of dogs that have received beauty treatment at their pet shops to the first to n-th user terminals 300-1 to 300-n. Therefore, they can advertise their pet shops to customers or further satisfy the existing customers with specific services.

Further, when the first to n-th client terminals 200-1 to 200-n have a display function (for example, for a show window), it is possible to display a rotation image after beauty treatment on a specific screen on the show window at their pet shops in order to advertise the pet shops.

Further, when the owners of pet shops manage an internet shopping mall for selling pet products, the first to n-th client terminals 200-1 to 200-n of the owners can take and upload rotation images of the products on the shopping malls so that the first to n-th user terminals 300-1 to 300-n can connect with the shopping malls and see the products.

To this end, the central server 100 can selectively provide two kinds of apps by request from the client terminal 200-1. That is, the central server 100 provides a rotation image-creating app that can perform the whole processes of taking a still image through the client terminal 200-1, processing the still image, and displaying a rotation image on a display unit of the client terminal 200-1 and a still image-creating app that can receive a still image taken by the client terminal 200-1, create a rotation image, and transmit it to the client terminal 200-1 so that the client terminal 200-1 displays the rotation image.

The two apps have camera driving control data keeping the photographing time, the photographing angle, and the number of times of photographing of the still image camera (for example, the camera of a terminal) so that the still image camera takes a plurality of still images of an object throughout 360 degrees, and when the still image camera is connected to a rotation system that rotates the still image camera, the apps further have photographing environment data for controlling a driving motor of the rotation system on the basis of the parameters set in the camera driving control data. According to the camera driving control data and the photographing environment data, the driving motor of the rotation system rotates the rotation system mounted with the camera while operating on the basis of the parameters set in the camera driving control data, and the camera photographs an object at the times and angles set in the camera driving control data, so a desired number of sequential still images can be obtained.

A camera connected to a rotation system or a display terminal connected with a digital camera can be connected with the driving motor of the rotation system through a connector using a USB cable so that it can be controlled, or it may be connected with the driving motor of the rotation system through local wireless communication such as Bluetooth so that it can be controlled, which is apparent in the art. To this end, the still image camera needs to be controlled such that local wireless communication that activates local wireless communication is possible.

The driving motor of the rotation system is controllably connected with a display terminal through a motor controller (motor control PCB) for controlling power supply. The motor controller needs a receiver for local wireless communication with a display terminal. The motor controller may be achieve by programming a Micom or a CPU on a PCB in order to automatically stop the driving motor when a signal is not transmitted to the receiver for a predetermined time. That is, the motor controller automatically stops the driving motor (shuts off the power), when a local wireless communication signal is not received after a display terminal finishes photographing and is then moved far away by a user.

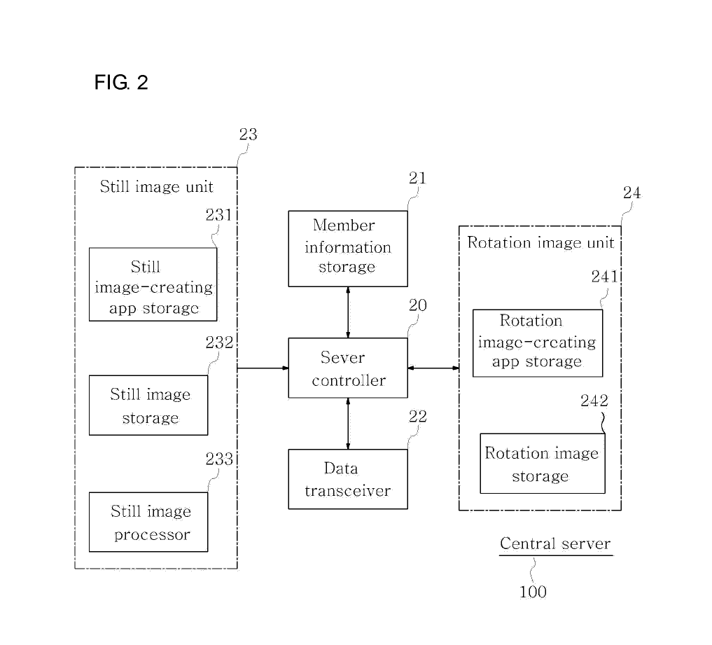

The apparatus for providing rotation images that can be applied in various ways is described in more detail with reference to FIGS. 2 to 4.

FIG. 2 is a block diagram illustrating in detail the central server illustrated in FIG. 1.

Referring to FIG. 2, the central server 100 includes a member information storage 21 that keeps member information of the client terminals or the user terminals (hereafter, referred to as terminals), a data transceiver that connects with the terminals to transmit/receive data, a still image unit 23 that keeps and processes still images, a rotation image unit 24 that keeps rotation images, and a server controller 20 that provides rotation images by selectively transmitting an app by request, by controlling those components.

The still image unit 23 is composed of a still image-creating app storage 231 that keeps the still image-creating app, a still image storage 232 that keeps still images transmitted from a terminal, and a still image processor 233 that creates rotation images by processing the still images in the still image storage 232.

The rotation image unit 24 is composed of a rotation image-creating app storage 241 that keeps the rotation image-creating app and a rotation image storage 242 that keeps rotation images from a terminal.

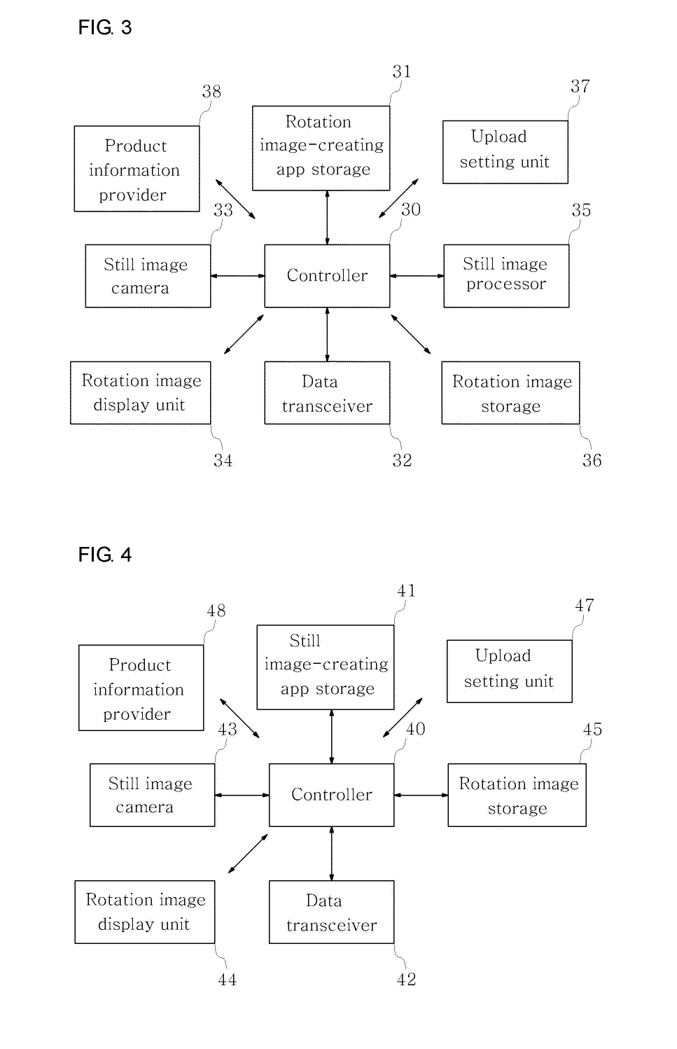

The operation of the apparatus for providing rotation images according to an embodiment of the present invention is described in detail with reference to the central server illustrated in FIG. 2 and FIG. 3.

FIG. 3 is a detailed block diagram of a terminal for illustrating an embodiment when a terminal makes a demand for the rotation image-creating app on the central sever 100 to make a rotation image by itself.

Referring to FIG. 3, a terminal includes a rotation image-creating app storage 31 that keeps a rotation image-creating app received from the central server 100 by request, a data transceiver 32 that transmits/receives data to/from the central server 100, a still image camera 33 that is operated by the rotation image-creating app and takes still images, a still image processor 35 that processes still images taken by the still image camera 33 to output them into rotation images, a rotation image storage 36 that keeps the rotation images processed by the still image processor 35, a rotation image display unit 34 that reads out and displays the rotation images in the rotation image storage 36, and a controller 30 that controls the components so that a plurality of still images are taken by the rotation image-creating app transmitted from the central server 100 and displayed in rotation images.

The rotation image display unit 34, for example, may be a touch screen through which a user can input an instruction to rotate an output image by touching the image. When an output rotation image on the rotation image display unit 34 is touched through the touch screen, the controller 30 controls the image to be rotated in the touch direction. On the other hand, when the rotation image display unit 34 is not a touch screen, an input for rotating an image may be made by a mouse cursor. The controller 30 controls the image outputted on the rotation image display unit 34 to be rotated in the movement direction of the mouse cursor.

In FIGS. 2 and 3, the controller 30 of FIG. 3 makes a demand for a rotation image-creating app on the central server 100 to make a rotation image by itself. The server controller 20 of the central server 100 reads out the requested rotation image-creating app from the rotation image-creating app storage 241 and transmits it to the terminal illustrated in FIG. 3 through the data transceiver 22. The controller 30 of the terminal stores the rotation image-creating app inputted through the data transceiver 32 into the rotation image-creating app storage 31. Thereafter, the controller 30 controls the still image inputted through the still image camera 33 to be outputted to the still image processor 35 and processed into a rotation image. The controller 30 illustrated in FIG. 3 stores the processed rotation image into the rotation image storage 36, and reads out and displays it through the rotation image display unit 34 by request from a user.

The operation of the apparatus for providing rotation images according to another embodiment of the present invention is described in detail with reference to the central server illustrated in FIG. 2 and FIG. 4.

FIG. 4 is a detailed block diagram of a terminal illustrating another embodiment when the terminal takes a still image, transmits it to the central server 100, and makes a demand for a still image-creating app, which makes it possible only to receive a rotation image from the central server 100 and display it, on the central server 100.

Referring to FIG. 4, a terminal includes a still image-creating app storage 41 that keeps a still image-creating app received from the central server 100 by request, a data transceiver 42 that connects with the central server 100, transmits a still image to the central server 100, and then receives a rotation image, a still image camera 43 that is operated by the still image-creating app to take a still image, a rotation image storage 45 that keeps a rotation image transmitted from the central server 100, a rotation image display unit 44 that reads out and displays the rotation image in the rotation image storage 45, and a controller 40 that controls the components so that a plurality of still image is taken by the still image-creating app transmitted from the central server 100 and transmitted to the central server 100, and the received rotation images are displayed. The rotation image display unit 44, as described above, may be a touch screen to rotate a rotation image in response to a touch or may be configured to rotate a rotation image by the cursor of a mouse.

In FIGS. 2 and 4, after the terminal takes a still image, the controller 40 of FIG. 4 makes a demand for a still image-creating app, which makes it possible only to transmit the still image to the central server 100 and receive and display a rotation image transmitted from the central server 100, on the central server 100. The server controller 20 of the central server 100 reads out the requested still image-creating app from the still image-creating app storage 231 and transmits it to the terminal illustrated in FIG. 4 through the data transceiver 22. The controller 40 of the terminal stores the still image-creating app inputted through the data transceiver 42 into the still image-creating app storage 41. Thereafter, the controller 40 transmits the still image inputted through the still image camera 43 to the central server 100 through the data transceiver 42.

The server controller 20 of the central server 100 of FIG. 2 receives a still image inputted through the data transceiver 22 and outputs it to the still image storage 232. Thereafter, the server controller 20 reads out the still image in the still image storage 232 outputs it to the still image processor 233 to be processed into a rotation image. The server controller 20 stores the processed rotation image into the rotation image storage 242.

Thereafter, the controller 40 of the terminal illustrated in FIG. 4 transmits a rotation image request signal to the central server 100 through the data transceiver 42. Then, the server controller 20 of the central server 100 illustrated in FIG. 2 reads out a stored rotation image from the rotation image storage 242 and transmits it to the terminal illustrated in FIG. 4 through the data transceiver 22.

The controller 40 illustrated in FIG. 4 stores the rotation image transmitted through the data transceiver 42 into the rotation image storage 45, and reads out and displays it through the rotation image display unit 44 by request from a user.

On the other hand, as illustrated in FIGS. 3 and 4, the terminals include upload setting units 37 and 47, respectively. The upload setting units 37 and 47 is set to upload a rotation image in the rotation image storages 36 and 45 to a specific website (linked website, for example, a shopping mall or a cloud), so it uploads the set rotation image to a specific website through the data transceivers 32 and 42. Accordingly, the rotation image is easily uploaded to a desired website by the upload setting units 37 and 47.

Further, the terminals include product information providers 38 and 48, as illustrated in the figures. The product information providers 38 and 48 keeps input product information so that the information on a product (product photographed by the still image camera) shown in a rotation image is posted with the rotation image on the specific website, and provide the product information to the upload setting units 37 and 47 so that the stored product information is uploaded with the rotation image to the specific website. That is, the product information is set to be uploaded by the upload setting units 37 and 47 and is uploaded with the rotation image to a specific website through the data transceivers 32 and 42. Accordingly, the specific website can automatically post the product information at a side of the rotation image. The product may be, for example, the size or feature and/or price of an article.

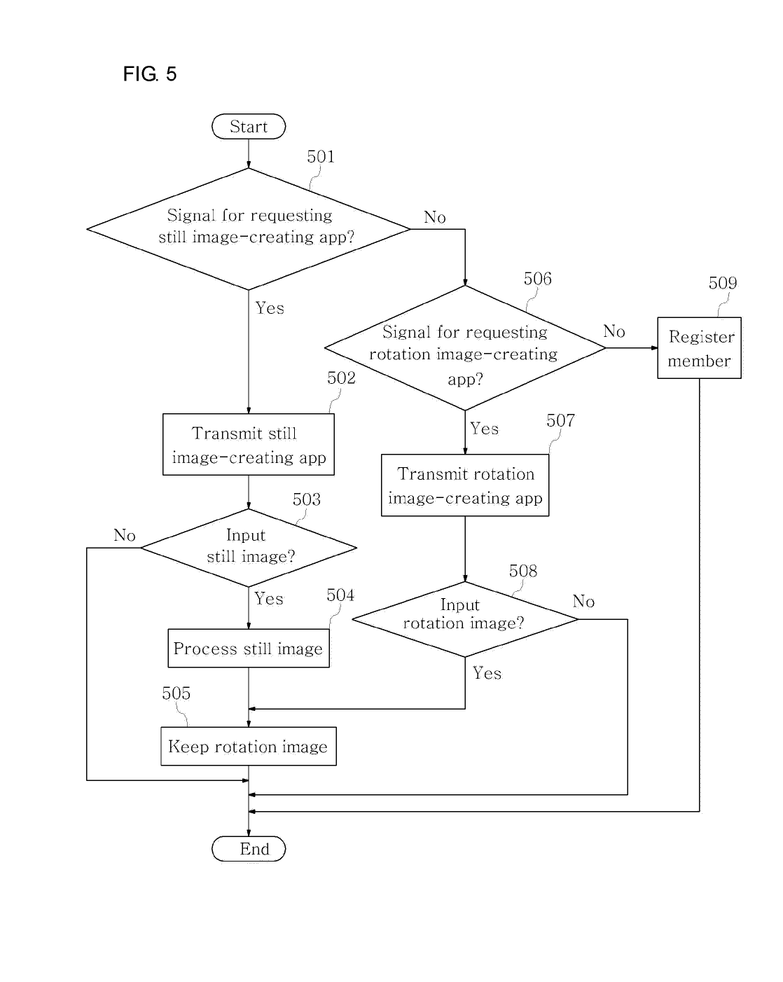

A method of providing a rotation image to a terminal from the central server 100 of the rotation image provider is described with reference to FIG. 5. FIG. 5 is a control flowchart illustrating a method of providing rotation images according to an embodiment of the present invention.

Referring to FIG. 5, the server controller 20 of the central server 100 determines first whether a requested signal is a signal for requesting a still image-creating app or a signal for requesting a rotation image-creating app. Further, it transmits the still image-creating app or the rotation image-creating app in accordance with the result of determination, and then processes and keeps a still image created and inputted by the still image-creating app into a rotation image or keeps a rotation image created and inputted by the rotation image-creating app.

In detail, the server controller 20 determines whether a requested signal is a signal for requesting a still image-creating app (step 501). As the result of determination, when it is not a signal for requesting a still image-creating app, it determines whether the requested signal is a signal for requesting a rotation image-creating app (step 506). As the result of determination, when it is not a signal for requesting a rotation image-creating app, it performs a process of registering a member (step 509).

On the other hand, when the requested signal is a signal for requesting a rotation image-creating app, as the result of determination in step 506, the rotation image-creating app is transmitted to the terminal requesting it (step 507). After the rotation image-creating app is transmitted, the server controller 20 determines whether a rotation image is inputted (step 508). When a rotation image is not inputted, as the result of determination, it stops, and when it is determined that a rotation image has been inputted, it keeps the input rotation image and then stops (Step 505). That is, when an image is inputted, the server controller 20 determines whether it is a rotation image, and then keeps the input rotation image.

Further, in step 501, when the server controller 20 determines that a signal for requesting a still image-creating app has been inputted, it transmits a still image-creating app to the terminal requesting it (step 502). After the still image-creating app is transmitted, the server controller 20 determines whether a still image is inputted (step 503). When a still image is not inputted, as the result of determination, it stops, and when it determines that a still image has been inputted, it processes the input still image to be outputted as a rotation image (step 504). Thereafter, it keeps the processed rotation image and then stops (step 505). That is, when a still image is inputted, the server controller 20 determines whether it is a still image, processes the input still image into a rotation image, and then keeps the processed still image.

After a rotation image is stored, the server controller 20 can upload the stored rotation image by transmitting it to a specific website (for example, a shopping mall or a cloud) set in accordance with the request signal. To this end, the server controller 20 determines whether an upload request signal has been inputted. When the server controller 20 determines that the signal has been inputted, it connects a specific website and transmits a stored rotation image. Thereafter, the server controller 20 transmits a message saying that the rotation image has been uploaded to the terminal requesting the rotation image to be uploaded.

When product information (for example, size, feature, or price) of an article (product) recorded in a rotation image is inputted, the server controller 20 can upload it by transmitting it to a specific website. To this end, the server controller 20 determines whether a signal for uploading product information has been inputted. When the server controller 20 determines that the signal has been inputted, it keeps the input product information. Further, the server controller 20 connects a specific website where the rotation image is uploaded, and transmits the stored product information. Thereafter, the server controller 20 transmits a message saying that the rotation image has been uploaded to the terminal requesting the rotation image to be uploaded. Accordingly, the specific website can post the product information at a side of the rotation image, together with the rotation image.

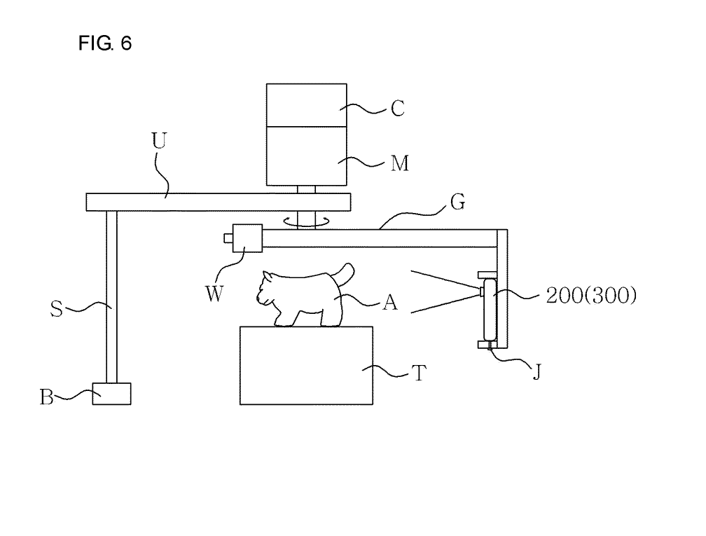

Referring to FIG. 6, the rotation system described above, for example, includes a post S having a base B, a horizontal member U horizontally disposed on the post S, a driving motor M disposed on the horizontal member U, a motor controller C controlling the driving motor M by controlling power for the driving motor M, and a swivel member G rotated about an object position A by the driving motor M.

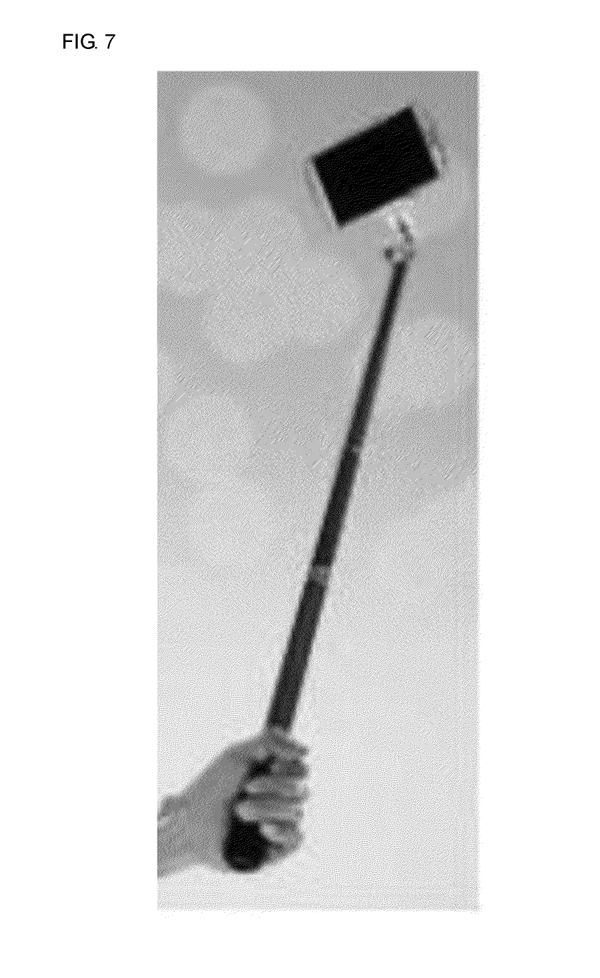

A client terminal 200 or a user terminal 300 equipped with a still image camera, that is, camera at a side, or a camera is detachably mounted on the swivel member G, as illustrated in the figure, by a jaw or a clamp such as a screw. The swivel member G may have a weight W for adjusting the center of gravity, opposite to the still image camera. The swivel member G may be achieved by a common selfie stick with the clamp described above (see FIG. 7).

The swivel member G is partially connected to a driving shaft of the driving motor M, as illustrated in the figure. When the driving motor M is operated by the motor controller C, the swivel member G, the swivel member G horizontally rotates about an object A (for example, a puppy) on a support such as a table T, as illustrated in the figure. Accordingly, the still image camera continuously photographs the object A at predetermined photographing angles while rotating about the object position A with rotation of the swivel member G.

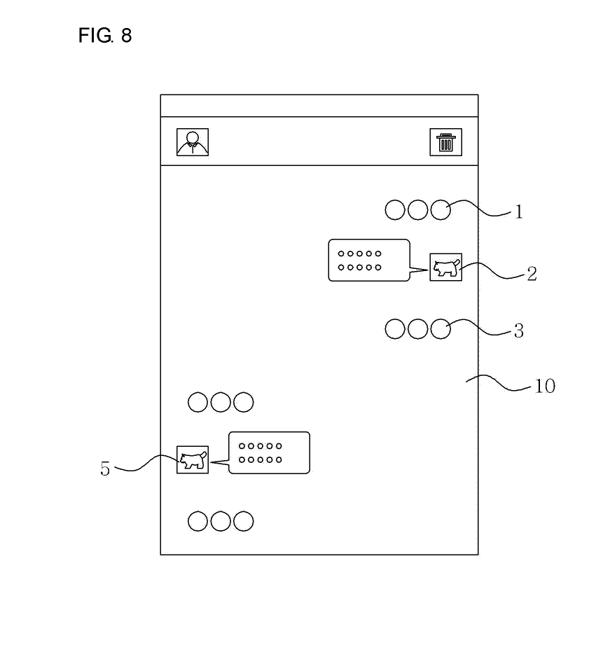

Referring to FIG. 8, the controller 30 of the terminal described above controls rotation images transmitted from the terminal that is being controlled to another terminal or rotation images transmitted from another terminal to be sequentially arranged and displayed in the order of reception on the rotation image display units 34 and 44. Further, the controller 30 controls any one of the rotation image transmitted from the terminal that is being controlled or the rotation image transmitted from another terminal to be reduced and displayed as picture icons 2 and 5 at a side or the other side of the rotation image display units 34 and 44. The controller 30 controls any one or a portion of the still images constituting a rotation image to be reduced and displayed at picture icons 2 and 5.

When the picture icons 2 and 5 are selected for rotation of the image, the controller 30 controls the picture icons 2 and 5 to be activated in a rotation image having a predetermined size and displayed on the rotation image display units 34 and 44. For example, when rotation images are transmitted or rotation image are received, the controller 30 reduces the transmitted and/or received rotation images and outputs them as picture icons on the rotation image display units 34 and 44 so that the rotation images can be seen through the screen 10 of the rotation image display units 34 and 44. Further, when the rotation image display units 34 and 44 are touch screens and the picture icons 2 and 5 are touched, the controller 30 expands the picture icons 2 and 5 to a predetermined size so that the rotation images can be seen, or restores the rotation images having the original sizes, and then outputs them to the display units 34 and 44.

Further, the controller 30, as illustrated in the figure, may control characters 1 showing the transmission time of a transmitted rotation image and the sender of a received rotation image or the reception time 3 of a received rotation image to be displayed on the rotation image display units 34 and 44. Accordingly, the controller 30 can show the sender and time of a rotation image transmitted or received through the screen 10 of the display units 34 and 44.

The controller 30 may control the rotation image display units 34 and 44 so that characters inputted to the terminal that is being controlled or received from another terminal are displayed in the type of a word bubble at a side of the picture icons 2 and 5. Accordingly, the controller 30 can show inputted or received characters.

Further, the controller 30 may control at least two rotation images kept in the rotation image storages 35 and 45 to be divisionally outputted on the screen 10 of the rotation image display units 34 and 44. The controller 30 controls the rotation image display units 34 and 44 such that a plurality of rotation images is divided into two to four sections on one screen 10 and rotation images touched or selected by a cursor, in the divided rotation images, are rotated. Accordingly, the control unit 30 can provide a plurality of rotation images such that they can be rotated at a time on one screen 10.

Further, the controller 30 may control the rotation image display units 34 and 44 such that when a rotation image outputted on one screen 10 is pulled up, the next rotation image is raised up from the bottom of the screen 10 and outputted. Accordingly, the controller 30 can continuously output rotation images not outputted in a standby state.

The present invention can be applied to a pet shop, an internet shopping mall, the social network, the show window of a store, and an exhibition hall.

As set forth above, according to exemplary embodiments of the invention, it is possible to rotate a plurality of still images taken by a camera at 360 degrees by simply touching the images with the cursor of a mouse or a finger, so not still images, but rotation images are displayed at all of angles, so an effect of pivoting an object is provided.

Further, a user can share a rotation image displayed like an actual object on his/her portable multimedia device with a plurality of users, so he/she can act in various social networks including a community, a café, and a blog.

Further, a user can stop and see a rotation angle at a desired angle by simply touching a screen or moving the cursor of a mouse and can rotate and see a product at a desired angle, so the user can see products in an internet shopping mall as actual objects.

Further, when the apparatus is connected to another display device and a rotation image is displayed on the device, it can be used for displaying products in various fields, including the show window of a store.

While the present invention has been illustrated and described in connection with the exemplary embodiments, it will be apparent to those skilled in the art that modifications and variations can be made without departing from the spirit and scope of the invention as defined by the appended claims.

What is claimed is:

1. An apparatus for providing a rotation image that is connected with a plurality of client terminals and/or user terminals and provides a rotation image, the apparatus comprising:
a data transceiver connected with the terminals to transmit/receive data;
a still image unit providing a still image-creating app to the terminals and keeping and processing received still images;
a rotation image unit providing a rotation image-creating app to the terminals and receiving and keeping rotation images; and
a server controller controlling the components so that any one of the apps is transmitted by request from a terminal and a rotation image is provided to a terminal requesting the rotation image.

2. The apparatus of claim 1, wherein the rotation image unit includes a rotation image-creating app storage keeping the rotation image-creating app and a rotation image storage keeping rotation images transmitted from the terminals.

3. The apparatus of claim 2, wherein the terminals each include: a rotation image-creating app storage keeping a requested and receive rotation image-creating app; a data transceiver transmitting/receiving data; a still image camera operated by the rotation image-creating app and taking still images; a still image processor processing still images taken by the still image camera to output them into rotation images; a rotation image storage keeping the rotation images processed by the still image processor; a rotation image display unit reading out and displaying the rotation images in the rotation image storage; and a controller controlling the components so that a plurality of still images are taken by received the rotation image-creating app and displayed in rotation images.

4. The apparatus of claim 3, wherein the rotation image display unit is a touch screen and the controller controls an output rotation image to be rotated when the touch screen is touched.

5. The apparatus of claim 3, wherein the apps have camera driving control data keeping the photographing time, the photographing angle, and the number of times of photographing of the still image camera so that the still image camera takes a plurality of still images of an object throughout 360 degrees, and when the still image camera is connected to a rotation system, the apps further have photographing environment data for controlling a driving motor of the rotation system on the basis of the parameters set in the camera driving control data.

6. The apparatus of claim 5, wherein the rotation system rotates the still image camera about an object position,
the rotation system includes: a swivel member to which the still image camera is detachably mounted and which is rotatable about the object position;
a driving motor rotating the swivel member; and
a motor controller controlling the driving motor by controlling power for the driving motor, and
the motor controller automatically stops the driving motor, when a signal for controlling the driving motor is not received for a predetermined time.

7. The apparatus of claim 3, wherein the controller controls rotation images transmitted from the terminal to another terminal or rotation images transmitted from another terminal to be sequentially arranged and displayed in the order of reception on the rotation image display unit, controls any one of the rotation image transmitted from the terminal or the rotation image transmitted from another terminal to be displayed as a picture icon at a side or the other side of the rotation image display unit, and controls the picture icons to be activated in a rotation image having a predetermined size and displayed on the rotation image display unit, when the picture icon is selected for rotation of the image.

8. The apparatus of claim 3, further comprising an upload setting unit setting rotation images in the rotation image storage to be transmitted and uploaded to a specific website.

9. The apparatus of claim 8, wherein further comprising a production information provider keeping product information so that product information of an article shown in the rotation image is set to be uploaded by the upload setting unit and uploaded with the rotation image to the specific website, and providing the stored product information to the upload setting unit.

10. The apparatus of claim 1, wherein the still image unit includes a still image-creating app storage keeping the sill image-creating app, a still image storage keeping still images transmitted from the terminals, and a still image processor creating rotation images by processing still images in the still image storage.

11. The apparatus of claim 10, wherein the terminals each include: a still image-creating app storage keeping a requested and received still image-creating app; a data transceiver transmitting still images to the still image unit and receiving rotation images from the data transceiver; a still image camera operated by the still image-creating app to take a still image; a rotation image storage keeping a rotation image transmitted from the data transceiver; a rotation image display unit reading out and displays the rotation image in the rotation image storage; and a controller controlling the components so that a plurality of still image is taken by the received still image-creating app and the received rotation images are displayed.

12. The apparatus of claim 11, wherein the rotation image display unit is a touch screen and the controller controls an output rotation image to be rotated when the touch screen is touched.

13. The apparatus of claim 11, wherein the apps have camera driving control data keeping the photographing time, the photographing angle, and the number of times of photographing of the still image camera so that the still image camera takes a plurality of still images of an object throughout 360 degrees, and when the still image camera is connected to a rotation system, the apps further have photographing environment data for controlling a driving motor of the rotation system on the basis of the parameters set in the camera driving control data.

14. The apparatus of claim 13, wherein the rotation system rotates the still image camera about an object position,
the rotation system includes: a swivel member to which the still image camera is detachably mounted and which is rotatable about the object position;
a driving motor rotating the swivel member; and
a motor controller controlling the driving motor by controlling power for the driving motor, and
the motor controller automatically stops the driving motor, when a signal for controlling the driving motor is not received for a predetermined time.

15. The apparatus of claim 11, wherein the controller controls rotation images transmitted from the terminal to another terminal or rotation images transmitted from another terminal to be sequentially arranged and displayed in the order of reception on the rotation image display unit, controls any one of the rotation image transmitted from the terminal or the rotation image transmitted from another terminal to be displayed as a picture icon at a side or the other side of the rotation image display unit, and controls the picture icons to be activated in a rotation image having a predetermined size and displayed on the rotation image display unit, when the picture icon is selected for rotation of the image.

16. The apparatus of claim 11, further comprising an upload setting unit setting rotation images in the rotation image storage to be transmitted and uploaded to a specific website.

17. The apparatus of claim 16, wherein further comprising a production information provider keeping product information so that product information of an article shown in the rotation image is set to be uploaded by the upload setting unit and uploaded with the rotation image to the specific website, and providing the stored product information to the upload setting unit.

18. The apparatus of claim 1, wherein the terminals each include: a rotation image-creating app storage keeping a requested and receive rotation image-creating app; a data transceiver transmitting/receiving data; a still image camera operated by the rotation image-creating app and taking still images; a still image processor processing still images taken by the still image camera to output them into rotation images; a rotation image storage keeping the rotation images processed by the still image processor; a rotation image display unit reading out and displaying the rotation images in the rotation image storage; and a controller controlling the components so that a plurality of still images are taken by received the rotation image-creating app and displayed in rotation images.

19. The apparatus of claim 18, wherein the rotation image display unit is a touch screen and the controller controls an output rotation image to be rotated when the touch screen is touched.

20. The apparatus of claim 18, wherein the apps have camera driving control data keeping the photographing time, the photographing angle, and the number of times of photographing of the still image camera so that the still image camera takes a plurality of still images of an object throughout 360 degrees, and when the still image camera is connected to a rotation system, the apps further have photographing environment data for controlling a driving motor of the rotation system on the basis of the parameters set in the camera driving control data.

21. The apparatus of claim 20, wherein the rotation system rotates the still image camera about an object position,
the rotation system includes: a swivel member to which the still image camera is detachably mounted and which is rotatable about the object position;
a driving motor rotating the swivel member; and
a motor controller controlling the driving motor by controlling power for the driving motor, and
the motor controller automatically stops the driving motor, when a signal for controlling the driving motor is not received for a predetermined time.

22. The apparatus of claim 18, wherein the controller controls rotation images transmitted from the terminal to another terminal or rotation images transmitted from another terminal to be sequentially arranged and displayed in the order of reception on the rotation image display unit, controls any one of the rotation image transmitted from the terminal or the rotation image transmitted from another terminal to be displayed as a picture icon at a side or the other side of the rotation image display unit, and controls the picture icons to be activated in a rotation image having a predetermined size and displayed on the rotation image display unit, when the picture icon is selected for rotation of the image.

23. The apparatus of claim 18, further comprising an upload setting unit setting rotation images in the rotation image storage to be transmitted and uploaded to a specific website.

24. The apparatus of claim 23, wherein further comprising a production information provider keeping product information so that product information of an article shown in the rotation image is set to be uploaded by the upload setting unit and uploaded with the rotation image to the specific website, and providing the stored product information to the upload setting unit.

25. The apparatus of claim 1, wherein the terminals each include: a still image-creating app storage keeping a requested and received still image-creating app; a data transceiver transmitting still images to the still image unit and receiving rotation images from the data transceiver; a still image camera operated by the still image-creating app to take a still image; a rotation image storage keeping a rotation image transmitted from the data transceiver; a rotation image display unit reading out and displays the rotation image in the rotation image storage; and a controller controlling the components so that a plurality of still image is taken by the received still image-creating app and the received rotation images are displayed.

26. The apparatus of claim 25, wherein the rotation image display unit is a touch screen and the controller controls an output rotation image to be rotated when the touch screen is touched.

27. The apparatus of claim 25, wherein the apps have camera driving control data keeping the photographing time, the photographing angle, and the number of times of photographing of the still image camera so that the still image camera takes a plurality of still images of an object throughout 360 degrees, and when the still image camera is connected to a rotation system, the apps further have photographing environment data for controlling a driving motor of the rotation system on the basis of the parameters set in the camera driving control data.

28. The apparatus of claim 27, wherein the rotation system rotates the still image camera about an object position,
the rotation system includes: a swivel member to which the still image camera is detachably mounted and which is rotatable about the object position;
a driving motor rotating the swivel member; and
a motor controller controlling the driving motor by controlling power for the driving motor, and
the motor controller automatically stops the driving motor, when a signal for controlling the driving motor is not received for a predetermined time.

29. The apparatus of claim 25, wherein the controller controls rotation images transmitted from the terminal to another terminal or rotation images transmitted from another terminal to be sequentially arranged and displayed in the order of reception on the rotation image display unit, controls any one of the rotation image transmitted from the terminal or the rotation image transmitted from another terminal to be displayed as a picture icon at a side or the other side of the rotation image display unit, and controls the picture icons to be activated in a rotation image having a predetermined size and displayed on the rotation image display unit, when the picture icon is selected for rotation of the image.

30. The apparatus of claim 25, further comprising an upload setting unit setting rotation images in the rotation image storage to be transmitted and uploaded to a specific website.

31. The apparatus of claim 30, wherein further comprising a production information provider keeping product information so that product information of an article shown in the rotation image is set to be uploaded by the upload setting unit and uploaded with the rotation image to the specific website, and providing the stored product information to the upload setting unit.

32. An apparatus for providing a rotation image that is connected with a plurality of client terminals and/or user terminals and provides rotation images, the apparatus comprising: a data transceiver connecting with the terminals to transmit/receive data; a rotation image unit providing a rotation image-creating app to the terminals and receiving and keeping rotation images; and a server controller controlling the components so that the rotation image-creating app is transmitted by request from a terminal, and a rotation image is transmitted from the terminal and then provided to the terminal,
wherein the terminals each include: a rotation image-creating app storage keeping a requested and receive rotation image-creating app; a data transceiver transmitting/receiving data to/from the data transceiver; a still image camera operated by the rotation image-creating app and taking still images; a still image processor processing still images taken by the still image camera to output them into rotation images; a rotation image storage keeping the rotation images processed by the still image processor; a rotation image display unit reading out and displaying the rotation images in the rotation image storage; and a controller controlling the components so that a plurality of still images are taken by received the rotation image-creating app and displayed in rotation images.

33. The apparatus of claim 32, wherein the rotation image display unit is a touch screen and the controller controls an output rotation image to be rotated when the touch screen is touched.

34. The apparatus of claim 32, wherein the apps have camera driving control data keeping the photographing time, the photographing angle, and the number of times of photographing of the still image camera so that the still image camera takes a plurality of still images of an object throughout 360 degrees, and when the still image camera is connected to a rotation system, the apps further have photographing environment data for controlling a driving motor of the rotation system on the basis of the parameters set in the camera driving control data.

35. The apparatus of claim 34, wherein the rotation system rotates the still image camera about an object position,
the rotation system includes: a swivel member to which the still image camera is detachably mounted and which is rotatable about the object position;
a driving motor rotating the swivel member; and
a motor controller controlling the driving motor by controlling power for the driving motor, and
the motor controller automatically stops the driving motor, when a signal for controlling the driving motor is not received for a predetermined time.

36. The apparatus of claim 32, wherein the controller controls rotation images transmitted from the terminal to another terminal or rotation images transmitted from another terminal to be sequentially arranged and displayed in the order of reception on the rotation image display unit, controls any one of the rotation image transmitted from the terminal or the rotation image transmitted from another terminal to be displayed as a picture icon at a side or the other side of the rotation image display unit, and controls the picture icons to be activated in a rotation image having a predetermined size and displayed on the rotation image display unit, when the picture icon is selected for rotation of the image.

37. The apparatus of claim 32, further comprising an upload setting unit setting rotation images in the rotation image storage to be transmitted and uploaded to a specific website.

38. The apparatus of claim 37, wherein further comprising a production information provider keeping product information so that product information of an article shown in the rotation image is set to be uploaded by the upload setting unit and uploaded with the rotation image to the specific website, and providing the stored product information to the upload setting unit.

39. An apparatus for providing a rotation image that is connected with a plurality of client terminals and/or user terminals and provides rotation images, the apparatus comprising: a data transceiver connecting with the terminals to transmit/receive data; a still image unit providing a still image-creating app to the terminals and keeping and processing received still images; and a server controller controlling the components so that the still image-creating app is transmitted by request from a terminal, and a still image transmitted from the terminal is processed and then provided as a rotation image to the terminal requesting the terminal,
wherein the terminals each include: a still image-creating app storage keeping a requested and received still image-creating app; a data transceiver transmitting still images and receiving rotation image; a still image camera operated by the still image-creating app to take a still image; a rotation image storage keeping a rotation image transmitted from the data transceiver; a rotation image display unit reading out and displays the rotation image in the rotation image storage; and a controller controlling the components so that a plurality of still image is taken by the received still image-creating app and the received rotation images are displayed.

40. The apparatus of claim 39, wherein the rotation image display unit is a touch screen and the controller controls an output rotation image to be rotated when the touch screen is touched.

41. The apparatus of claim 39, wherein the apps have camera driving control data keeping the photographing time, the photographing angle, and the number of times of photographing of the still image camera so that the still image camera takes a plurality of still images of an object throughout 360 degrees, and when the still image camera is connected to a rotation system, the apps further have photographing environment data for controlling a driving motor of the rotation system on the basis of the parameters set in the camera driving control data.

42. The apparatus of claim 41, wherein the rotation system rotates the still image camera about an object position,
the rotation system includes: a swivel member to which the still image camera is detachably mounted and which is rotatable about the object position;
a driving motor rotating the swivel member; and
a motor controller controlling the driving motor by controlling power for the driving motor, and
the motor controller automatically stops the driving motor, when a signal for controlling the driving motor is not received for a predetermined time.

43. The apparatus of claim 39, wherein the controller controls rotation images transmitted from the terminal to another terminal or rotation images transmitted from another terminal to be sequentially arranged and displayed in the order of reception on the rotation image display unit, controls any one of the rotation image transmitted from the terminal or the rotation image transmitted from another terminal to be displayed as a picture icon at a side or the other side of the rotation image display unit, and controls the picture icons to be activated in a rotation image having a predetermined size and displayed on the rotation image display unit, when the picture icon is selected for rotation of the image.

44. The apparatus of claim 39, further comprising an upload setting unit setting rotation images in the rotation image storage to be transmitted and uploaded to a specific website.

45. The apparatus of claim 44, wherein further comprising a production information provider keeping product information so that product information of an article shown in the rotation image is set to be uploaded by the upload setting unit and uploaded with the rotation image to the specific website, and providing the stored product information to the upload setting unit.

46. A method of providing a rotation image that provides rotation images in connection with a plurality of client terminals and/or user terminals that request an app, the method comprising:
a first step of transmitting any one of a still image-creating app or a rotation image-creating app to a terminal requesting the app in response to a requested signal; and
a second step of processing or keeping an input still image to be outputted at a rotation image or keeping an input rotation image, when any one of a still image and a rotation image is inputted, after the still image-creating app or the rotation image-creating app is transmitted.

47. The method of claim 46, wherein the first step include:
a step 1-1 that determines whether the requested signal is a signal for requesting a still image-creating app;
a step 1-2 that determines whether the requested signal is a signal for requesting a rotation image-creating app, when the requested signal is not a signal for requested a still image-creating app, as the result of determination;
a step 1-3 that transmits a rotation image-creating app to a terminal requesting the rotation image-creating app, when the requested signal is a signal for requesting a rotation image-creating app, as the result of determination in the step 1-2; and
a step 1-4 that transmits a still image-creating app to a terminal requesting the still image-creating app, when the requested signal is a signal for requesting a still image-creating app, as the result of determination in the step 1-1.

48. The method of claim 46, wherein the second step includes: determining whether the input image is a still image; processing an input still image to be outputted as a rotation image, when the input image is determined as a still image; and keeping the processed rotation image.

49. The method of claim 46, wherein the second step includes: determining whether the input image is a rotation image; and keeping an input rotation image when the input image is determined as a rotation image.

50. A method of providing a rotation image that provides rotation images in connection with a plurality of client terminals and/or user terminals that request an app, the method comprising:
a first step of determining whether a requested signal is a signal for requesting a still image-creating app;
a second step of determining whether the requested signal is a signal for requesting a rotation image-creating app, when the requested signal is not a signal for requesting a still image-creating app, as the result of determination;
a third step of transmitting a rotation image-creating app to a terminal requesting the rotation image-creating app, when the requested signal is a signal for requesting a rotation image-creating app, as the result of determination in the second step;
a fourth step of keeping an input rotation image, when the rotation image is inputted, after the rotation image-creating app is transmitted;
a fifth step of transmitting a still image-creating app to a terminal requesting the still image-creating app, when a signal for requesting a still image-creating app is inputted in the first step;
a sixth step of determining whether a still image is inputted, after the still image-creating app is transmitted;
a seventh step of processing an input still image to be outputted as a rotation image, when the still image is inputted, as the result of determination in the sixth step; and
an eighth step of keeping the processed rotation image.
